(19) United States
(12) Patent Application Publication
(10) Pub. No.: US 2016/0129406 A1
(43) Pub. Date: May 12, 2016

(54) APPARATUS AND METHODS FOR ENHANCING HYDRATION

(71) Applicant: SCHLUMBERGER TECHNOLOGY CORPORATION, Sugar Land, TX (US)

(72) Inventors: Jonathan Wun Shiung Chong, Sugar Land, TX (US); Jijo Oommen Joseph, Houston, TX (US); Garud Bindiganavale Sridhar, Sugar Land, TX (US); William Troy Huey, Fulshear, TX (US)

(21) Appl. No.: 14/539,419

(22) Filed: Nov. 12, 2014

(51) Int. Cl. B01F 11/02

(52) U.S. Cl. CPC B01F 11/02

(57) ABSTRACT

An apparatus, which includes an aqueous fluid source, a hydratable material source, a fluid pathway transporting an aqueous solution comprising aqueous fluid from the aqueous fluid source and hydratable material from the hydratable material source, and an emitter operable to emit ultrasonic energy into the aqueous solution.

### BACKGROUND OF THE DISCLOSURE

High viscosity fluids or gels comprising hydratable material additives mixed with water or aqueous fluid containing water are used in subterranean well treatment operations. These high viscosity fluids or gels are may be formulated at a job site or transported to the job site from a remote location. Hydration is a process by which the hydratable material solvates, absorbs, or otherwise combines with water to create the high viscosity fluids or gels. The level of hydration of the hydratable material may be increased by maintaining the hydratable material in the aqueous fluid during a process step referred to as residence time, such as may take place in one or more tanks.

Hydration and the associated increase in viscosity take place over a time span corresponding to the residence time of the hydratable material in the aqueous fluid. Hence, the rate of hydration of the hydratable material is a factor in the hydration operations, particularly in continuous hydration operations wherein the high viscosity fluid or gel is produced at the job site during the course of well treatment operations. To achieve sufficient hydration and/or viscosity, long tanks or a series of tanks are utilized to provide the hydratable material with sufficient residence time in the aqueous fluid. Such tanks are transported to or near the job site where the well treatment fluids are used. For example, the hydratable material may be mixed with the aqueous fluid before being introduced into a series of tanks and, as the mixture passes through the series of tanks, the hydratable material may hydrate to a sufficient degree.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an apparatus that includes an aqueous fluid source, a hydratable material source, and a fluid pathway transporting an aqueous solution that includes the aqueous fluid and hydratable material sources. The apparatus also includes an emitter that emits ultrasonic energy into the aqueous solution.

The present disclosure also introduces a method that includes combining aqueous fluid and hydratable solid particles in a fluid pathway to form an aqueous solution conducted by the fluid pathway. Ultrasonic energy is imparted to the aqueous solution with an emitter.

The present disclosure also introduces a method that includes communicating an aqueous solution having a hydratable material through a fluid pathway. Ultrasonic energy is imparted to the aqueous solution with an emitter to enhance hydration of the hydratable material.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of apparatus according to one or more aspects of the present disclosure.

FIG. 2 is a schematic view of an example implementation of the apparatus shown in FIG. 1 according to one or more aspects of the present disclosure.

FIG. 3 is a schematic view of an example implementation of a portion of the apparatus shown in FIG. 2 according to one or more aspects of the present disclosure.

FIG. 4 is a graph related to one or more aspects of the present disclosure.

FIG. 5 is a flow-chart diagram of at least a portion of a method according to one or more aspects of the present disclosure.

FIG. 6 is a flow-chart diagram of at least a portion of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the context of the present disclosure, intensification is the imparting of energy into a mixture of a hydratable material and an aqueous fluid. Intensification may be operable to enhance the dispersion of the hydratable material within the aqueous fluid and, therefore, reduce hydration time of the hydratable material in the aqueous fluid and increase the yield of the hydratable material in the aqueous fluid. The mixture of the hydratable material and the aqueous fluid is referred to hereinafter as an aqueous solution. The yield may be defined as a predetermined or steady-state percent hydration level (i.e., the percentage of hydratable material that is hydrated) that is reached during the course of hydration, and the hydration time may be defined as the amount of residence time that is sufficient for the aqueous solution to reach a steady-state or a predetermined yield and/or viscosity during the course of hydration. Because the viscosity of the aqueous solution is a function of percent hydration, wherein the viscosity level of the aqueous solution increases as the percentage hydration increases, the yield may also be defined as a predetermined or steady-state viscosity level reached during the course of hydration.

Energy emitted by an intensification device, such as an emitter of ultrasonic energy, may intensify the hydratable material and/or the aqueous solution, whereby the ultrasonic energy may enhance and/or increase the rate of dispersion of the hydratable material and, therefore, reduce hydration time of hydratable material particles in the aqueous fluid. The ultrasonic energy released by the emitter may also increase the yield of the aqueous solution. Therefore, the increase in the yield may increase the viscosity of the aqueous solution or permit a predetermined viscosity level with a decreased amount of hydratable material in the aqueous solution.

Another intensification device, such as a cavitation device, may also be operable to impart energy into the hydratable material and/or the aqueous solution. The cavitation device may enhance and/or increase the rate of dispersion of the hydratable material and reduce the hydration time of the hydratable material in the aqueous fluid. The cavitation device may also increase the yield of the aqueous solution similarly to the emitter of ultrasonic energy as described above.

The hydratable material may comprise various materials, including natural materials, modified materials, inorganic materials, organic materials, synthetic materials, and combinations thereof. The hydratable material may comprise hydratable polymers, such as polysaccharides, biopolymers, and other polymers. For example, the polymers may include arabic gums, karaya gums, xanthan, tragacanth gums, ghatti gums, carrageenan, psyllium, acacia gums, tamarind gums, guar gums, locust bean gums, and/or others. Modified gums, such as carboxymethyl guar and hydroxypropyl guar, may also be used. Also, galactomannans, such as guar, including natural, modified, or derivative galactomannans, may be used. The hydratable material may further comprise celluloses, such as modified celluloses, and cellulose derivatives, such as cellulose ether, cellulose ester, or any water-soluble cellulose ether. The hydratable material may also comprise hydratable clays, such as bentonite, montmorillonite, laponite, and the like. The hydratable material may further comprise hydratable synthetic polymers and copolymers, which may include, polyacrylate, polymethylacrylate, acrylamide-acrylate, and maleic anhydride methyl vinyl ether.

The hydratable material may be provided in a variety of forms. For example, the hydratable material may be in a solid particulate form, such as a fine powder or a granular solid. The hydratable material may also be in the form of a slurry or solid particles suspended in oil. A hydratable material in the form of a slurry or solid particles suspended in oil may be referred to as a liquid gel concentrate.

The aqueous fluid comprises water, which may be fresh water, sea water, or other fluids comprising water.

The aqueous solution may be provided in various concentrations of hydratable material. The hydratable material may have a concentration in the aqueous solution that is equal to a predetermined concentration at the point of use. For example, the hydratable material may be combined with the aqueous fluid at a rate ranging between about one pound (or about 0.4 kilgrams) to about 300 pounds (or about 136 kilgrams) of the hydratable material per about 1,000 gallons (or about 3,785 liters) of aqueous fluid. Increasing the amount of hydratable material present in the aqueous solution may increase the viscosity of the aqueous solution following hydration. Accordingly, hydratable material may be added to the aqueous solution in amounts sufficient to obtain a predetermined final viscosity of the aqueous solution following hydration.

The hydratable material may have a concentration in the aqueous solution that may be greater than the intended concentration at the point of use. For example, the aqueous solution may be provided with a hydratable material concentration ranging between about 20 pounds (or about 9 kilgrams) and about 500 pounds (or about 227 kilgrams) of hydratable material per about 1,000 gallons (or about 3,785 liters) of aqueous fluid. Following intensification by the emitter and/or the cavitation device, the aqueous solution having such concentrations of hydratable material may be diluted with additional aqueous fluid to result in an aqueous solution having a final concentration and, therefore, final viscosity that is suitable for use in the intended application.

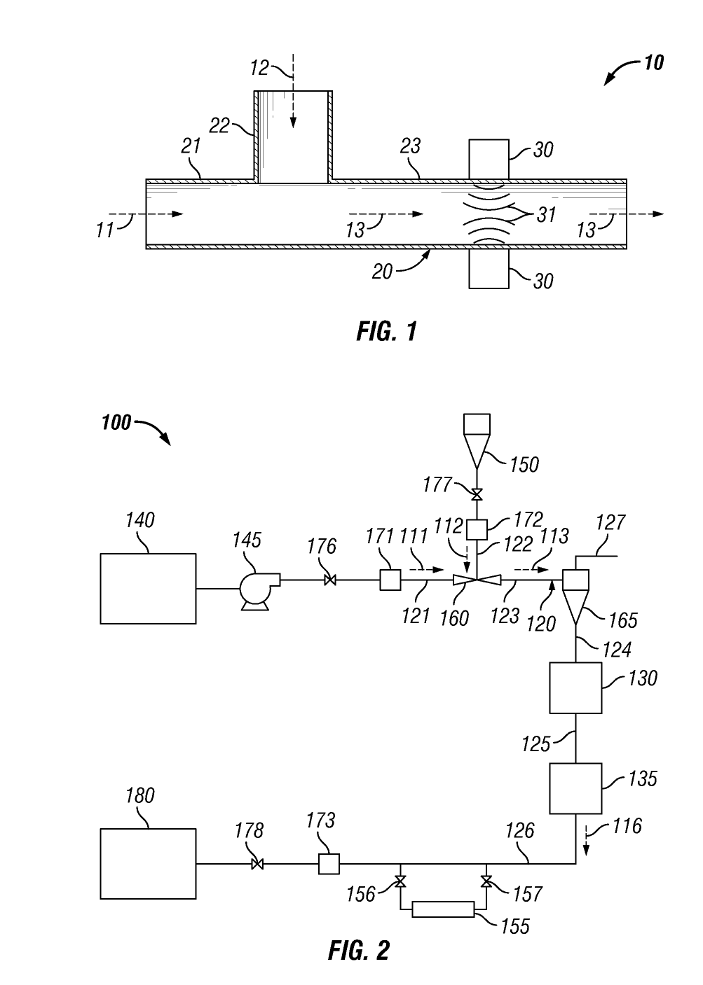

FIG. 1 is a schematic view of at least a portion of an intensification system 10 according to one or more aspects of the present disclosure. The intensification system 10 comprises a fluid pathway 20 and an emitter 30, such as may be operable for emitting ultrasonic energy into a mixture flowing in the fluid pathway 20. The fluid pathway 20 may include a first inlet 21 and a second inlet 22. The first inlet 21 may communicate an aqueous fluid (not shown) into the fluid pathway 20, as shown by an arrow 11. The second inlet 22 may communicate a hydratable material (not shown) into the fluid pathway 20, as shown by arrow 12. The mixture of aqueous fluid and hydratable material, hereinafter referred to as the aqueous solution (not shown), is then communicated through a combined pathway 23 of the fluid pathway 20, as shown by arrows 13. Although FIG. 1 depicts a single first inlet 21 and a single second inlet 22, the fluid pathway 20 may comprise another number of inlets, such as pipes and/or other conduits (hereafter collectively referred to as conduits) connected in series or in parallel, which may each or collectively be operable for communicating the aqueous fluid and the hydratable material into the combined pathway 23 of the fluid pathway 20. Although FIG. 1 depicts a single combined pathway 23, the fluid pathway 20 may comprise a plurality of fluid pathways (e.g., see FIG. 2), such as may be formed by one or more conduits connected in series or in parallel, which may each or collectively be operable to communicate the aqueous solution. The fluid pathway 20 may further comprise one of more devices (e.g., see FIG. 2) fluidly connected along the fluid pathway 20 that may also form portions of the fluid pathway 20.

The intensification system 10 is shown comprising separate inlets 21, 22 operable for communicating the aqueous fluid and the hydratable material into the fluid pathway 20. However, the aqueous solution may be prepared prior to entry into the fluid pathway 20. For example, the aqueous solution may be prepared at a remote location and then introduced into the fluid pathway 20 through the first inlet 21, the second inlet 22, and/or another inlet in fluid connection with the combined pathway 23. For example, under such circumstances, the fluid pathway 20 may comprise a single inlet for communicating the aqueous solution therein.

The emitter 30 may be or comprise one or more emitters of ultrasonic energy 31, such as one or more ultrasonic generators, ultrasonic transducers, ultrasonic transmitters, and/or other devices operable to impart ultrasonic energy 31 to the aqueous solution. The emitter may be operable to emit ultrasonic energy ranging between about 50 watts and about 200 watts per liter of aqueous solution per minute.

The emitter 30 may comprise various devices that convert energy into ultrasound and/or high frequency sound waves. The emitter 30 may include a piezoelectric transducer, a capacitive transducer, a magnetostrictive transducer, and/or other devices that emit ultrasonic energy 31. The emitter 30 may be positioned about and/or adjacent to the fluid pathway 20, such as may permit the emitter 30 to impart ultrasonic energy 31 to the aqueous solution. The fluid pathway 20 may include a conduit comprising at least a portion having a material that permits transmission and/or penetration of the ultrasonic energy 31 from the emitter 30 into the aqueous solution. For example, the emitter 30 may be positioned in direct contact with the aqueous solution and/or in or proximate a window or opening along the conduit forming at least a portion of the combined pathway 23, including implementations in which the emitter 30 may extend through the window or opening in the conduit, perhaps such that the emitter 30 is in direct contact with the aqueous solution.

The emitter 30 may also or instead comprise an ultrasonic emitter assembly (not shown) having an emitter portion and a fluid chamber portion that are coupled together. The fluid chamber portion may be fluidly coupled along the combined pathway 23, such as may permit the aqueous solution to be communicated through the fluid chamber portion as the emitter portion imparts the aqueous solution with ultrasonic energy 31.

FIG. 2 is a schematic view of at least a portion of an intensification system 100 according to one or more aspects of the present disclosure, representing an example implementation of the intensification system 10 shown in FIG. 1. The intensification system 100 may comprise a first inlet 121, a second inlet 122, and a plurality of fluid conduits 123, 124, 125, 126 fluidly connected to form at least a portion of a fluid pathway 120. Although FIG. 2 shows two inlets 121, 122 and four fluid conduits 123, 124, 125, 126, the intensification system 100 may comprise another number of inlets and conduits connected in series or in parallel, such as may permit the introduction and communication of an aqueous fluid (not shown) and a hydratable material (not shown) into and through the fluid pathway 120, while also permitting the fluid connection of various components of the intensification system 100, such as the example components described below.

The intensification system 100 may further comprise a hydratable material source 150, an aqueous fluid source 140, and an emitter 130 of ultrasonic energy. The hydratable material source 150 may comprise a hopper or another container, such as may permit the hydratable material in the form of solid particles or liquid gel concentrate to be stored therein and fed into the fluid pathway 120 through the inlet 122, as shown by arrow 112. However, the hydratable material may also or instead be continuously or otherwise transported from another location to the intensification system 100 and fed into the source 150 and/or directly into the fluid pathway 120 through the inlet 122.

The aqueous fluid source 140 may comprise a receptacle, a storage tank, a reservoir, a conduit, and/or other object that may contain or communicate the aqueous fluid. The aqueous fluid may be supplied into the fluid pathway 120 through the inlet 121, as shown by arrow 111. The aqueous fluid may be communicated into the fluid pathway 120 by a pump 145, such as may be operable to pressurize and/or move the aqueous fluid from the aqueous fluid source 140 and/or through the inlet 121 and the fluid conduits 123, 124, 125, 126. The pump 145 may move the aqueous fluid from the source 140 into the fluid pathway 120 at a flow rate ranging between about five barrels per minute (BPM) and about thirty BPM. However, the flow rate may be as high as about 120 BPM. The inlets 121, 122 may be operable to communicate the aqueous fluid and the hydratable material into the fluid pathway 120 to permit mixing and/or combining of the aqueous fluid and the hydratable material to form an aqueous solution (not shown), which may be communicated through the fluid pathway 120, as shown by arrow 113. The aqueous solution may flow through the fluid pathway 120 and the devices along the fluid pathway at a flow rate ranging between about five BPM and about thirty BPM. However, the flow rate may be as high as about 120 BPM.

The intensification system 100 may further comprise a mixing device 160, such as may be operable to mix or otherwise combine the aqueous fluid and the hydratable material. The mixing device 160 may include an eductor, a shearing pump, an agitator, an inline mixer, and/or other mixing devices, such as may be operable to receive therein, mix, and/or combine the aqueous fluid and the hydratable material. For example, the intensification system 100 may comprise an eductor that may receive therein the hydratable material from the hydratable material source 150, wherein the hydratable material in the form of solid particles or liquid gel concentrate may be fed or washed into the fluid pathway 120 through the inlet 122, which may be part of the eductor. The eductor may further receive therein the aqueous fluid from the aqueous fluid source 140, wherein the aqueous fluid may be communicated into the fluid pathway 120 through the inlet 121, which may be part of the eductor.

Although the intensification system 100 is shown comprising separate sources 140, 150 of aqueous fluid and hydratable material fluidly connected to the mixing device 160, the intensification system 100 may also or instead comprise a source (not shown) of aqueous solution, such as may permit the introduction of an aqueous solution that is prepared prior to entry into the fluid pathway 120. For example, the aqueous solution may be prepared at a remote location and then introduced into the fluid pathway 120 through the first inlet 121, the second inlet 122, and/or another inlet to the fluid pathway 120. In such implementations, the intensification system 100 may comprise a single inlet for communicating the aqueous solution therein, while the mixing device 160 and the sources 140, 150 of aqueous fluid and hydratable material may be omitted and replaced by a source of aqueous solution.

FIG. 2 further shows the intensification system 100 comprising a liquid/gas separator 165 disposed downstream of the mixing device 160. The liquid/gas separator 165 may be operable to separate out and remove air and other gas that may have been introduced into the aqueous solution during the mixing process and/or otherwise trapped in the hydratable material and/or the aqueous fluid prior to mixing. The liquid/gas separator 165 may receive the aqueous solution from the conduit 123, vent the air or other gas through conduit 127, and communicate the aqueous solution into conduit 124. The liquid/gas separator 165 may include a gravity separator, a cyclonic separator, a filter vane separator, a liquid/gas coalescer, and/or other liquid/gas separators operable to remove air or other gas from the aqueous solution.

The intensification system 100 further comprises an emitter 130 of ultrasonic energy, such as may be operable to impart ultrasonic energy to the aqueous solution that is communicated through the fluid pathway 120. The emitter 130 may be substantially as described above with respect to the emitter 30 shown in FIG. 1. For example, the emitter 130 may comprise one or more devices that convert energy into ultrasound and/or high frequency sound waves. The emitter 130 may be coupled along the fluid pathway 120 between conduits 124, 125 and/or another location along the fluid pathway downstream of the mixing device 160. The intensification system 100 may also comprise multiple instances of the emitter 130 disposed at one or multiple locations along the fluid pathway 120.

The intensification system 100 may further comprise a cavitator 135, such as may be operable to generate hydrodynamic cavitation within the aqueous solution. For example, the cavitator 135 may comprise a rotor (not shown) containing therein a plurality of radially extending cavities. As the rotor is rotated at high speeds, low pressure regions of aqueous solution are created at the bottom of the cavities, resulting in the formation of fluid free spaces or bubbles. Such spaces continuously form and collapse, releasing shockwaves through the aqueous solution. As the aqueous solution flows through the cavitator 135, the shockwaves impart energy into the aqueous solution to enhance and/or increase the rate of dispersion of the hydratable material and, therefore, reduce hydration time of hydratable material particles in the aqueous fluid. The shockwave intensification may also increase the yield of the aqueous solution. Although a rotor type cavitator is described above, a shear mixer and/or other devices operable to induce cavitation in the aqueous solution may also or instead be included as part of the intensification system 100. The cavitator 135 may be coupled along the fluid pathway 120 between conduits 125, 126, or at another location along the fluid pathway downstream of the mixing device 160. The intensification system 100 may also comprise multiple instances of the cavitator 135 disposed at one or multiple locations downstream of the mixing device 160.

As the aqueous solution flows past the emitter 130 and/or through the cavitator 135, ultrasonic energy or shock energy is imparted or supplied to the aqueous solution. This supply of energy may increase the rate of hydration of the hydratable material in the aqueous solution. Although the aqueous solution may be subjected to these sources of energy for a relative short period of time (e.g., less than about five or ten minutes), such ultrasonic and/or shock energy may still stimulate the hydratable material in a manner effective to sufficiently increase the rate of hydration. For example, the emitter 130 may emit ultrasonic energy to induce cavitation in the aqueous fluid and/or induce vibrations of the hydratable material, such as may increase dispersion of the hydratable material in the aqueous fluid. Similarly, the cavitator 135 may induce shocks in the aqueous solution, such as may also increase dispersion of the hydratable material in the aqueous fluid. Furthermore, the energy imparted by the emitter 130 and/or the cavitator 135 may break coagulated clusters of the hydratable material that may be suspended in the aqueous fluid, which may increase the surface area of contact between the hydratable material and the aqueous fluid. Such increased surface area of contact may facilitate faster hydration of the hydratable material. The ultrasonic or shock energy may also prevent coagulation or the formation of clumps of hydratable material in the aqueous fluid.

After intensification by the emitter 130 and/or the cavitator 135, the hydratable material may continue to undergo hydration until the hydratable material is sufficiently hydrated and/or until the aqueous solution is used (e.g., pumped downhole, whether directly or via one or more other surface components at the wellsite). For example, the aqueous solution may flow downstream, as indicated by arrow 116, perhaps into a receptacle 180 where additional hydration may occur after passing the emitter 30 and/or the cavitator 135 and/or where the aqueous solution may be stored for later use. Once the hydratable material is sufficiently hydrated, the aqueous solution may be used for a variety of uses, such as in fracturing fluids or other drilling fluids.

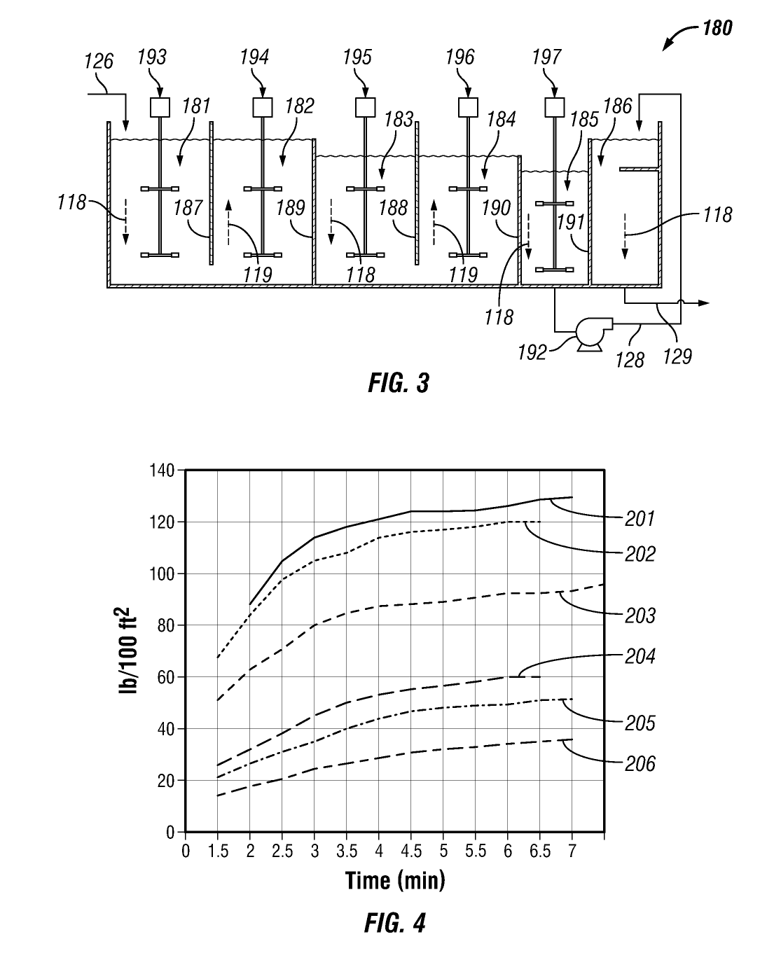

The receptacle 180 may be or comprise a continuous mixing receptacle 180. FIG. 3 is a schematic view of an example implementation of at least a portion of the continuous mixing receptacle 180 according to one or more aspects of the present disclosure. The continuous mixing receptacle 180 may be or comprise a vessel-type receptacle having a single space or open area (not shown), an elongated receptacle (not shown), a receptacle having a first-in-first-out mode of operation, and/or other receptacles that may permit storage and/or communication of the aqueous solution.

The continuous mixing receptacle 180 may comprise a series of tanks 181-186 forming a flow path through the continuous mixing receptacle 180. Each of the tanks 181-186 may have a downward flow path, as indicated by arrows 118, or an upward flow path, as indicated by arrows 119. Thus, for example, the aqueous solution entering the first tank 181 via the conduit 126 may flow downward through the tank 181, then under a first separator wall 187, and then upward through the next tank 182. In the second tank 182, the upward flow causes the aqueous solution to pass over a separator 189 and into the next tank 183. In a manner similar to tanks 181, 182, the aqueous solution flows downward through the tank 183, then under a second separator wall 188, then upward through the next tank 184, and then over a second separator 190 into the next tank 185. The aqueous solution then flows downward through the tank 185 and is pumped through a conduit 128 into the final tank 186 by a pump 192. Once in the tank 186, the aqueous solution flows downward and out of the tank 186 through a conduit 129. The continuous mixing receptacle 180 may further comprise impeller assemblies 193-197, such as may be operable to stir or otherwise agitate the aqueous solution within the tanks 181-185 and/or encourage the above-described flow directions.

Because the intensification process may increase the hydration rate of the hydratable material compared to a baseline hydration rate, the receptacle 180 may be omitted from the intensification system 100 if sufficient hydration takes place prior to final use of the aqueous solution. For example, sufficient hydration of the aqueous solution may be achieved by the intensification of the ultrasonic energy of the emitter 130 and/or the cavitation shocks of the cavitator 135 as the aqueous solution communicates through the fluid pathway 120. However, a smaller continuous mixing receptacle 180 having a shorter (with respect to physical dimensions and/or time) flow path may still be included as part of the intensification system 100, such as to ensure sufficient hydration and/or viscosity levels. For example, the continuous mixing receptacle 180 may comprise a lesser number of tanks, such as between two and five tanks, as the residence time for the hydratable material to reach sufficient hydration may be less than a baseline residence time in which intensification devices are not utilized.

As further depicted in FIG. 2, the intensification system 100 may also comprise various sensors, measuring devices, and/or flow control valves operable for controlling various functions of the intensification system 100. For example, the intensification system 100 may comprise one or more of a first flow sensor 171, a second flow sensor 172, a third flow sensor 173, a first flow control valve 176, a second flow control valve 177, a third flow control valve 178, and a viscometer 155, which may each or collectively be operable to measure various properties and control flow rates of the aqueous fluid, the hydratable material, and the aqueous solution. The sensors 171-173, viscometer 155, and/or other sensing devices may output corresponding signals to a data acquisition apparatus or a controller (not shown). During hydration operations, the sensors 171, 172, 173, 155 and the valves 176, 177, 178 may be operable to monitor and/or control the rate of production, the level of hydration, the level of viscosity, and/or the concentration of the aqueous solution.

In the example implementation depicted in FIG. 2, the first flow sensor 171 may be disposed at the first inlet 121 and may be operable to measure the volumetric and/or mass flow rate of the aqueous fluid or the premixed aqueous solution that is introduced into the flow pathway 120 through the first inlet 121. The second flow sensor 172 may be disposed at the second inlet 122 and may be operable to measure the volumetric and/or mass flow rate of the hydratable material or the premixed aqueous solution that is introduced into the flow pathway 120 through the second inlet 122. If the hydratable material comprises liquid gel concentrate or the premixed aqueous solution, the second flow sensor 172 may comprise a fluid flow sensor operable to measure the volumetric and/or mass flow rate of the hydratable material. If the hydratable material comprises solid particles, the second flow sensor 172 may comprise a dry or particulate flow sensor operable to measure the volumetric and/or mass flow rate of the hydratable material. The third flow sensor 173 may be disposed along the conduit 126 downstream from the emitter 130 and/or the cavitator 135 and may be operable to measure the volumetric and/or mass flow rate of the aqueous solution.

The viscometer 155 may be disposed along the conduit 126 and may comprise one or more viscosity sensors operable to measure shear stress and/or viscosity of the aqueous solution. As the viscosity of the aqueous solution is measured by the viscometer 155, the input flow rate of the aqueous fluid or the aqueous solution through the first inlet 121 and the input flow rate of the hydratable material or the aqueous solution through the second inlet 122 may be adjusted based on the viscosity measurements.

For example, if the measured viscosity of the aqueous solution is greater than the intended viscosity, the viscosity of the aqueous solution may be decreased by increasing the input flow rate of the aqueous fluid through the first inlet 121 and/or by decreasing the input flow rate of the hydratable material through the second inlet 122. The input flow rate of the aqueous fluid may be increased by further opening the first flow control valve 176 disposed downstream of the first inlet 121, or by increasing the output flow rate of the pump 145 downstream of the aqueous fluid source 140. The input flow rate of the hydratable material through the second inlet 122 may be decreased by restricting the flow rate of the hydratable material with the second flow control valve 177 disposed downstream of the second inlet 122. If the hydratable material comprises liquid gel concentrate or the premixed aqueous solution, the second flow control valve 177 may comprise a fluid flow control valve. However, if the hydratable material comprises solid particles, the second flow control valve 177 may comprise a volumetric or mass dry metering device operable to control the volumetric or mass flow rate of the hydratable material fed from the hydratable material source 150. Similarly, if the viscosity of the aqueous solution measured by the viscometer 155 is lower than the intended viscosity, the viscosity of the aqueous solution may be increased by decreasing the input flow rate of the aqueous fluid through the first inlet 121 via control of the first flow control valve 176 and/or by increasing the input flow rate of the hydratable material through the second inlet 122 by further opening the second flow control valve 177.

The third flow sensor 173 may be utilized to measure the output volumetric or mass flow of the aqueous solution, including the aqueous fluid and the hydratable material introduced through the first and second inlets 121, 122. If the measured output flow of the aqueous solution is lower than the intended output flow, the input flow rates of the aqueous fluid and the hydratable material may be increased as described above, whereas if the measured output flow rate of the aqueous solution is higher than the intended output flow, the input flow rates of the aqueous fluid and the hydratable material may be decreased as described above. Instead, or in addition to using the first and second flow control valves 176, 177, a third flow control valve 178 disposed downstream of the emitter 130 and/or the cavitator 135 may be opened or closed to increase or decrease, respectively, the output rate of the aqueous fluid. It should be noted that the combination of the flow control valves 176, 177, 178 may be further operable to increase and decrease the residence time of the aqueous solution in the conduit 126 and/or the receptacle 180 prior to final use. For example, slower output rates permit the aqueous solution to remain in the conduit 126 and/or the receptacle 180 for a longer period of time prior to final use.

In addition to controlling various flow and/or output rates of the aqueous solution, as described above, the level of intensification may also be controlled or otherwise regulated to control the rate of hydration of the hydratable material in the aqueous solution. For example, the power output of the emitter 130 may be controlled to either increase or decrease the rate at which ultrasonic energy is imparted into the mixture of the hydratable material in the aqueous fluid, which may be operable to control the rate of hydration of the hydratable material. For example, the power output of the emitter 135 may be regulated between about zero watts and about fifty watts (or more) of ultrasonic energy per liter of the aqueous solution per minute.

The power output of the emitter 135 may also be controlled by regulating the number of discrete emitters that may be disposed along the fluid pathway 120. For example, the emitter 130 may include a plurality of discrete emitters, which may be individually activated to impart ultrasonic energy into the aqueous solution, whereby a lower portion of activated discrete emitters collectively impart less ultrasonic energy into the aqueous solution, while a larger portion of activated discrete emitters collectively impart more ultrasonic energy into the aqueous solution.

Furthermore, the power output of the cavitator 135 may also be controlled or otherwise regulated to either increase or decrease the rate at which shock energy is imparted into the mixture of the hydratable material in the aqueous fluid. For example, the rotor of the cavitator 135 may be regulated between lower and higher rotational speeds, whereby at lower rotational speeds energy may be imparted into the aqueous solution at lower rates, while at higher rotational speeds energy may be imparted into the aqueous solution at higher rates. The power output may also be regulated by increasing or decreasing the number of rotors that are rotated within the cavitator 135, whereby a lower number of rotating rotors may impart less energy into the aqueous solution, while a greater number of rotating rotors may impart more energy into the aqueous solution.

The rate of hydration may also be controlled or otherwise regulated by increasing or decreasing the temperature of the aqueous solution. By introducing additional heat energy into the aqueous solution, the hydratable material may be intensified to increase the rate of dispersion and, therefore, the rate of hydration of the hydratable material. For example, a heater (not shown) may be coupled or otherwise disposed along the first inlet 121, the second inlet 122, and/or the fluid pathway 120, such as may be operable to impart heat energy into the aqueous solution. As the rate of hydration of the hydratable material may be related to the temperature of the aqueous solution, the power output of the heater may be regulated to increase the temperature of the aqueous solution to a predetermined level.

Controlling the rate of hydration may be operable to control the hydration time and, therefore, decrease the residence time of the hydratable material. The rate of hydration may be increased, for example, if no receptacle 180 is used as part of the intensification system 100 and/or if the conduit 126 is relatively short. Under these circumstances, a higher rate of hydration may enable the hydratable material to reach a predetermined yield at the point of use, which may be, for example, in close proximity to the intensification system 100. The rate of hydration may be decreased, for example, if a receptacle 180 is used as part of the intensification system 100 and/or if the conduit 126 is relatively long, thereby increasing the residence time, such as may permit the hydratable material to reach a predetermined yield. Furthermore, the rate of hydration may be increased, for example, if the output flow rate through the fluid pathway 120 is increased. Under these circumstances, the residence time may be decreased below the hydration time. Therefore, increasing the rate of hydration may decrease the hydration time, enabling the hydratable material to reach a predetermined yield prior to reaching the point of use. An experimental application of an ultrasonic emitter similar to the emitter 30 shown in FIG. 1 and/or the emitter 130 shown in FIG. 2 was conducted on an aqueous solution. In such experiment, water was fed through a fluid cavity of the ultrasonic emitter at a rate of about four liters per minute, and a sufficient amount of guar was added to produce an aqueous solution having a concentration of eighty pounds (or about 36.3 kilgrams) of guar per 1,000 gallons (or about 3,785 liters) of fresh water. The aqueous solution was imparted with seventy watts of ultrasonic energy. Thereafter, the shear stress of the aqueous solution was continuously measured and recorded for a period of about five minutes. Shear stress measurements started about 1.5 minutes following the ultrasonic energy intensification and ended about 6.5 minutes following the intensification. The experiment was also conducted with an aqueous solution having a concentration of forty pounds (or about 18.1 kilgrams) of guar per 1,000 gallons (or about 3,785 liters) of fresh water and an aqueous solution having a concentration of sixty pounds (or about 27.2 kilgrams) of guar per 1,000 gallons (or about 3,785 liters) of fresh water. Shear stress measurements were also taken with each aqueous solution before being intensified by the ultrasonic emitter. FIG. 4 is a chart showing the experimental results.

The chart in FIG. 4 depicts the relationship between the measured shear stress (in oilfield units of pounds per 100 square feet) against time (in minutes) following intensification by the ultrasonic emitter. Curves 201, 202, 203 depict the relationship between shear stress and time for the aqueous solutions having the 80, 60, and 40 pound guar concentrations, respectively, which were each intensified with 70 watts of ultrasonic energy. Curves 204, 205, 206 depict the relationship between shear stress and time for the aqueous solutions having the 80, 60, and 40 pound guar concentrations, respectively, which were not intensified with ultrasonic energy. As the viscosity of a fluid may be calculated by dividing the shear stress of the fluid by the shear rate of the fluid, the viscosity and the rate of change of viscosity of the aqueous solutions may be directly related to the shear stress and the rate of change of shear stress of the aqueous solution. Accordingly, viscosity measurements may be performed by measuring the shear stress of the aqueous solution and dividing the results by the shear rate of the viscometer during such measurements.

As can be seen in FIG. 4, the rate of increase of shear stress readings shown in curves 201, 202, 203 during a time period between 1.5 and 3 minutes was higher than the respective increase in shear stress readings shown in curves 204, 205, 206 during the same time period. The differences between the curves indicate that prior to reaching steady-state percent hydration (i.e., yield), the rate of hydration (indicated by the slope of each curve) of the intensified aqueous solution is higher than the rate of hydration of the aqueous solution that was not imparted with ultrasonic energy. As can be further seen in FIG. 4, the shear stress readings shown in curves 201, 202, 203 were about two to three times higher than the respective shear stress readings shown in curves 204, 205, 206. These differences indicate that the yield of the intensified aqueous solutions is higher than the yield of the aqueous solutions that were not imparted with ultrasonic energy.

Another experiment (not shown) was conducted on an aqueous solution having an eighty pound guar concentration flowing at a rate of four liters per minute, in which the aqueous solution was subjected to 220 watts of ultrasonic energy. At an energy input rate of about 50 to 55 watts, breakdown of guar bonds was experienced, resulting in a decrease in shear stress readings.

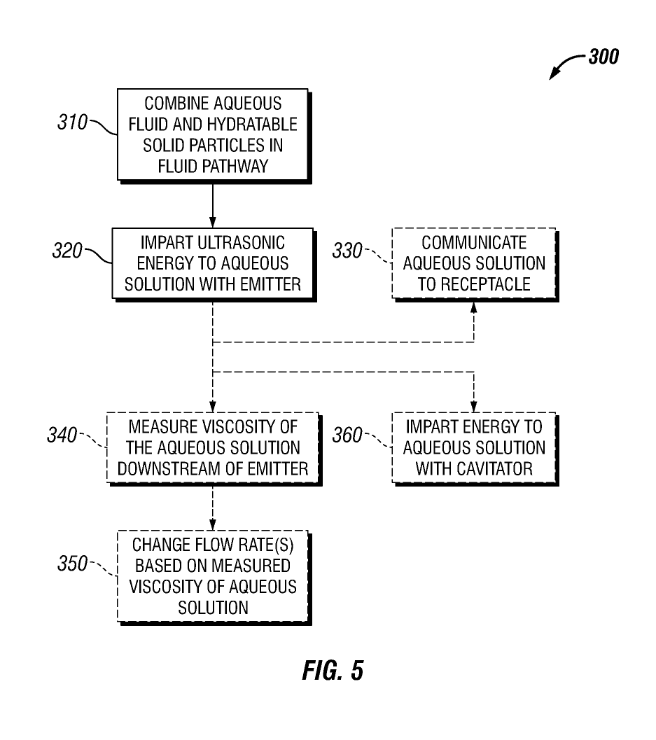

FIG. 5 is a flow-chart diagram of at least a portion of an example implementation of a method (300) according to one or more aspects of the present disclosure. The method (300) may utilize at least a portion of an intensification system such as the intensification system 10 shown in FIG. 1 and/or the intensification system 100 shown in FIG. 2. Thus, the following description refers to FIGS. 1, 2, and 5, collectively.

The method (300) comprises combining (310) an aqueous fluid and hydratable solid particles in a fluid pathway 20, 120 and imparting (320) ultrasonic energy to the combined aqueous fluid and hydratable solid particles with an emitter 30, 130. As described above, imparting (320) ultrasonic energy to the combined aqueous fluid and hydratable solid particles with the emitter 30, 130 may increase the rate of dispersion and the rate of hydration of the hydratable solid particles. As also described above, imparting (320) ultrasonic energy to the combined aqueous fluid and hydratable solid particles with the emitter 30, 130 may also or instead induce vibrations of the hydratable material in the aqueous solution and break coagulated hydratable material in the aqueous solution, which may increase the rate of hydration of the hydratable material. Imparting (320) ultrasonic energy to the combined aqueous fluid and hydratable solid particles with the emitter 30, 130 may also or instead increase a percentage of hydratable material that is hydrated and/or increase the viscosity of the aqueous solution. As described above, the emitter 30, 130 may impart up to about 50 watts of ultrasonic energy per liter of the combined aqueous fluid and hydratable solid particles per minute.

The method (300) may optionally comprise communicating (330) the combined aqueous fluid and hydratable solid particles to a receptacle after imparting ultrasonic energy to the combined aqueous fluid and hydratable solid particles, such as the continuous mixing receptacle 180 shown in FIG. 3 and/or another receptacle. The method (300) may also comprise measuring (340) viscosity of the combined aqueous fluid and hydratable solid particles downstream of the emitter 30, 130 and increasing or decreasing (350) a rate of communication of the combined aqueous fluid and hydratable solid particles through the fluid pathway 20, 120 based on the measured viscosity of the aqueous solution.

The method (300) may also comprise imparting (360) energy to the combined aqueous fluid and hydratable solid particles with a cavitator apparatus. For example, imparting (360) energy to the combined aqueous fluid and hydratable solid particles with a cavitator apparatus may utilize the cavitator apparatus 135 shown in FIG. 2.

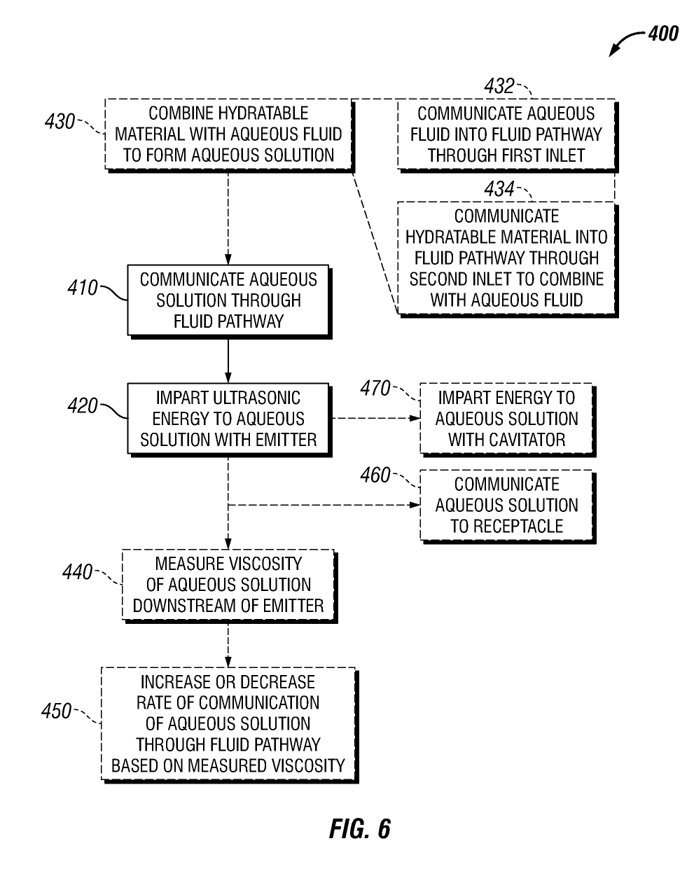

FIG. 6 is a flow-chart diagram of at least a portion of an example implementation of a method (400) according to one or more aspects of the present disclosure. The method (400) may utilize at least a portion of an intensification system such as the intensification system 10 shown in FIG. 1 and/or the intensification system 100 shown in FIG. 2. Thus, the following description refers to FIGS. 1, 2, and 6, collectively.

The method (400) may comprise communicating (410) an aqueous solution comprising a hydratable material through a fluid pathway 20, 120 and imparting (420) ultrasonic energy to the aqueous solution with an emitter 30, 130 to enhance hydration of the hydratable material. The fluid pathway 20, 120 may comprise one or more fluid conduits 123, 124, 125, and the hydratable material may comprise at least one of a polymer, a synthetic polymer, a galactomannan, a polysaccharide, a cellulose, and/or a clay. As described above, the emitter 30, 130 may impart up to about 50 watts of ultrasonic energy per liter of the aqueous solution per minute.

The method (400) may further comprise combining (430) the hydratable material with an aqueous fluid to form the aqueous solution. For example, as described above, the intensification system 100 may comprise first and second inlets 21, 121, 22, 122, and combining (430) the hydratable material with the aqueous fluid to form the aqueous solution may comprise communicating (432) the aqueous fluid into the fluid pathway 20, 120 through the first inlet 21, 121 and communicating (434) the hydratable material into the fluid pathway 20, 120 through the second inlet 22, 122 to combine with the aqueous fluid and thereby form the aqueous solution.

The method (400) may further comprise measuring (440) viscosity of the aqueous solution downstream of the emitter 30, 130 and increasing or decreasing (450) a rate of communication of the aqueous solution through the fluid pathway 20, 120 based on the measured viscosity of the aqueous solution. Measuring (440) viscosity of the aqueous solution downstream may utilize a viscometer 75 downstream of the emitter 30, 130, and increasing or decreasing (450) a rate of communication of the aqueous solution through the fluid pathway 20, 120 based on the measured viscosity of the aqueous solution may utilize corresponding flow control valves 76, 77.

The method (400) may also comprise communicating (460) the aqueous solution to a continuous mixing receptacle 180 and/or other receptacle fluidly connected with the fluid pathway 20, 120 after imparting ultrasonic energy to the aqueous solution. The method (400) may also comprise imparting (470) energy to the aqueous solution with a cavitator 135 to further enhance hydration of the hydratable material.

In view of the entirety of the present disclosure, including the figures and the claims, a person having ordinary skill in the art should readily recognize that the present disclosure introduces an apparatus comprising: an aqueous fluid source; a hydratable material source; a fluid pathway transporting an aqueous solution comprising the aqueous fluid and hydratable material sources; and an emitter operable to emit ultrasonic energy into the aqueous solution.

The apparatus may further comprise a receptacle fluidly connected with the fluid pathway downstream of the emitter. The receptacle may be a continuous mixing receptacle, such as a first-in-first-out continuous mixing receptacle. Such apparatus may further comprise a viscosity sensor operable for sensing a viscosity of the aqueous source between the emitter and the receptacle, and/or a viscosity sensor operable for sensing a viscosity of the aqueous source downstream from the emitter.

The apparatus may further comprise a mixer operable to mix the aqueous solution. The mixer may be disposed upstream or downstream of the emitter.

The hydratable material may substantially comprise guar. The hydratable material may also or instead comprise at least one of a polymer, a synthetic polymer, a galactomannan, a polysaccharide, a cellulose, and/or a clay.

The emitter may be operable to emit ultrasonic energy at up to about fifty watts per liter of aqueous solution per minute. The emitter may also or instead be operable to emit ultrasonic energy at up to about 200 watts.

The apparatus of claim 1 wherein the aqueous solution flows past the emitter at a flow rate ranging between about five BPM and about thirty BPM.

The apparatus may further comprise a pump operable to pump aqueous fluid from the aqueous fluid source into the fluid pathway. The pump may be operable to pump aqueous fluid from the aqueous fluid source into the fluid pathway at a flow rate ranging between about five BPM and about thirty BPM.

The apparatus may further comprise a cavitator operable to induce cavitation in the aqueous solution. The cavitator may comprise a shear mixer.

The present disclosure also introduces a method comprising: combining aqueous fluid and hydratable solid particles in a fluid pathway to form an aqueous solution conducted by the fluid pathway; and imparting ultrasonic energy to the aqueous solution with an emitter. The method may further comprise communicating the aqueous solution to a receptacle after imparting ultrasonic energy to the aqueous solution. The hydratable solid particles may comprise at least one of a polymer, a synthetic polymer, a galactomannan, a polysaccharide, a cellulose, and/or a clay. Imparting ultrasonic energy to the aqueous solution with the emitter may comprise imparting up to about fifty watts of ultrasonic energy per liter of the aqueous solution per minute with the emitter.

The method may further comprise: measuring viscosity of the aqueous solution downstream of the emitter; and increasing or decreasing a rate of communication of the aqueous solution through the fluid pathway based on the measured viscosity of the aqueous solution. The method may further comprise imparting energy to the aqueous solution with a cavitator apparatus.

The present disclosure also introduces a method comprising: communicating an aqueous solution comprising a hydratable material through a fluid pathway; and imparting ultrasonic energy to the aqueous solution with an emitter to enhance hydration of the hydratable material. The fluid pathway may comprise one or more fluid conduits.

The method may further comprise combining the hydratable material with an aqueous fluid to form the aqueous solution. Combining the hydratable material with the aqueous fluid to form the aqueous solution may comprise: communicating the aqueous fluid into the fluid pathway through a first inlet; and communicating the hydratable material into the fluid pathway through a second inlet to combine with the aqueous fluid to thereby form the aqueous solution.

The method may further comprise: measuring viscosity of the aqueous solution downstream of the emitter; and increasing or decreasing a rate of communication of the aqueous solution through the fluid pathway based on the measured viscosity of the aqueous solution.

The method may further comprise communicating the aqueous solution to a receptacle fluidly connected with the fluid pathway after imparting ultrasonic energy to the aqueous solution.

Imparting ultrasonic energy to the aqueous solution with the emitter to enhance hydration of the hydratable material may comprise imparting up to about fifty watts of ultrasonic energy per liter of the aqueous solution per minute with the emitter.

The hydratable material may comprise at least one of a polymer, a synthetic polymer, a galactomannan, a polysaccharide, a cellulose, and/or a clay.

The method may further comprise imparting energy to the aqueous solution with a cavitator apparatus.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same uses and/or achieving the same benefits of the embodiments introduced herein. A person having ordinary skill in the art should also realize that such equivalent constructions do not depart from the scope of the present disclosure, and that they may make various changes, substitutions and alterations herein without departing from the spirit and scope of the present disclosure.

The Abstract at the end of this disclosure is provided to comply with 37 C.F.R. §1.72(b) to permit the reader to quickly ascertain the nature of the technical disclosure. It is submitted with the understanding that it will not be used to interpret or limit the scope or meaning of the claims.

What is claimed is:

1. An apparatus, comprising:
an aqueous fluid source;
a hydratable material source;
a fluid pathway transporting an aqueous solution comprising the aqueous fluid and hydratable material sources; and
an emitter operable to emit ultrasonic energy into the aqueous solution.

2. The apparatus of claim 1 further comprising a receptacle fluidly connected with the fluid pathway downstream of the emitter, wherein the receptacle is at least one of a continuous mixing receptacle and a first-in-first-out continuous mixing receptacle.

3. The apparatus of claim 2 further comprising a viscosity sensor operable for sensing a viscosity of the aqueous source between the emitter and the receptacle.

4. The apparatus of claim 1 further comprising a viscosity sensor operable for sensing a viscosity of the aqueous source downstream from the emitter.

5. The apparatus of claim 1 further comprising a mixer operable to mix the aqueous solution.

6. The apparatus of claim 1 wherein the hydratable material substantially comprises guar.

7. The apparatus of claim 1 wherein the hydratable material comprises at least one of a polymer, a synthetic polymer, a galactomannan, a polysaccharide, a cellulose, and/or a clay.

8. The apparatus of claim 1 wherein the emitter is operable to emit ultrasonic energy at up to about 50 watts per liter of aqueous solution per minute.

9. The apparatus of claim 1 wherein the emitter is operable to emit ultrasonic energy at up to about 200 watts.

10. The apparatus of claim 1 further comprising a cavitator operable to induce cavitation in the aqueous solution.

11. The apparatus of claim 10 wherein the cavitator comprises a shear mixer.

12. A method, comprising:
combining aqueous fluid and hydratable solid particles in a fluid pathway to form an aqueous solution conducted by the fluid pathway; and
imparting ultrasonic energy to the aqueous solution with an emitter.

13. The method of claim 12 further comprising:
measuring viscosity of the aqueous solution downstream of the emitter; and
increasing or decreasing a rate of communication of the aqueous solution through the fluid pathway based on the measured viscosity of the aqueous solution.

14. The method of claim 12 further comprising imparting energy to the aqueous solution with a cavitator apparatus.

15. A method, comprising:
communicating an aqueous solution comprising a hydratable material through a fluid pathway; and
imparting ultrasonic energy to the aqueous solution with an emitter to enhance hydration of the hydratable material.

16. The method of claim 15 further comprising combining the hydratable material with an aqueous fluid to form the aqueous solution.

17. The method of claim 16 wherein combining the hydratable material with the aqueous fluid to form the aqueous solution comprises:
communicating the aqueous fluid into the fluid pathway through a first inlet; and
communicating the hydratable material into the fluid pathway through a second inlet to combine with the aqueous fluid to thereby form the aqueous solution.

18. The method of claim 15 further comprising:
measuring viscosity of the aqueous solution downstream of the emitter; and
increasing or decreasing a rate of communication of the aqueous solution through the fluid pathway based on the measured viscosity of the aqueous solution.

19. The method of claim 15 wherein imparting ultrasonic energy to the aqueous solution with the emitter to enhance hydration of the hydratable material comprises imparting up to about fifty watts of ultrasonic energy per liter of the aqueous solution per minute with the emitter.

20. The method of claim 15 further comprising imparting energy to the aqueous solution with a cavitator apparatus.
